(19) United States
(12) Patent Application Publication
(10) Pub. No.: US 2026/0202319 A1
(43) Pub. Date: Jul. 16, 2026

(54) DUAL FREQUENCY COMB SPECTROSCOPY ENABLING ATTACHMENT FOR MOBILE DEVICES

(71) Applicant: Honeywell International Inc., Charlotte, NC (US)

(72) Inventor: Daniel James Yee, Charlotte, NC (US)

(21) Appl. No.: 19/413,219

(22) Filed: Dec. 9, 2025

Related U.S. Application Data
(60) Provisional application No. 63/743,896, filed on Jan. 10, 2025.

(51) Int. Cl. G01N 21/25; G01N 21/27

(52) U.S. Cl. CPC G01N 21/255; G01N 21/27; G01N 2201/0221

(57) ABSTRACT

A system for integrating dual frequency comb spectroscopy (DFCS) functionality into and/or with a mobile device. The system comprises an attachment configured to couple with a mobile device; and DFCS-enabling hardware that is configured to enable the mobile device to perform DFCS-based molecular analysis of a sample area comprising a sample, wherein the DFCS-enabling hardware comprises a laser emitter configured to generate two optical frequency combs that emit laser light at evenly spaced intervals across a broad spectrum of optical frequencies, wherein (i) the laser light is directed towards the sample area, and (ii) at least a portion of the laser light is received by at least one photodetector configured to (a) receive at least a portion of the laser light after interacting with the sample, and (b) generate signal output data based on one or more wavelength or absorption properties corresponding to the portion of the laser light.

### CROSS REFERENCE TO RELATED APPLICATION

This application claims the priority of U.S. Provisional Application No. 63/743,896, entitled “DUAL FREQUENCY COMB SPECTROSCOPY ENABLING ATTACHMENT FOR MOBILE DEVICES,” filed on January 10, 2025, the disclosure of which is hereby incorporated by reference in its entirety.

### BACKGROUND

Spectroscopy may be used to detect and analyze chemical compounds, gases, and other substances in real-time. However, traditional spectroscopy equipment is often bulky, expensive, and/or requires specialized training to operate, thereby limiting its accessibility and portability. As an alternative, chemical test kits may be portable and easy to use but often lack the precision and real-time analysis capabilities provided by spectroscopic technology, such as dual frequency comb spectroscopy (DFCS). Although more compact than traditional spectroscopy equipment, portable spectrometers may still be costly and may not offer a same level of integration and ease of use as DFCS-enabled devices. Applicant has identified many disadvantages associated with conventional spectroscopy devices.

### BRIEF SUMMARY

Various embodiments described herein relate to components, apparatuses, and systems for integrating dual frequency comb spectroscopy (DFCS) functionality into and/or with a mobile device.

According to some embodiments, a system comprises an attachment configured to couple with a mobile device; and DFCS-enabling hardware that is configured to enable the mobile device to perform DFCS-based molecular analysis of a sample area comprising a sample, wherein the DFCS-enabling hardware comprises a laser emitter configured to generate two optical frequency combs that emit laser light at evenly spaced intervals across a broad spectrum of optical frequencies, wherein (i) the laser light is directed towards the sample area, and (ii) at least a portion of the laser light is received by at least one photodetector configured to (a) receive at least a portion of the laser light after interacting with the sample, and (b) generate signal output data based on one or more wavelength or absorption properties corresponding to the portion of the laser light; and an optical coupling system configured to direct the laser light from the laser emitter into the sample area.

In some embodiments, the two optical frequency combs comprise a pump comb and a probe comb that are combined to focus light onto the sample area. In some embodiments, the portion of the laser light is reflected from the sample, and the at least one photodetector comprises an internal photodetector that is positioned adjacent to the laser emitter and is configured to receive the portion of the laser light at a proximate range. In some embodiments, the portion of the laser light is transmitted through the sample, and the at least one photodetector comprises an external photodetector positioned at a distance from the laser emitter and is configured to receive the portion of the laser light at a distant range that covers the sample area. In some embodiments, the at least one photodetector comprises an internal photodetector positioned adjacent to the laser emitter and configured to detect reflected light from the sample; and an external photodetector positioned at a distance from the laser emitter and configured to detect transmitted light that passes through the sample. In some embodiments, a first signal output generated by the external photodetector is combined with a second signal output generated by the internal photodetector. In some embodiments, a combination of the first signal output and the second signal output is provided to a phase-locked loop (PLL) control system to generate one or more PLL signals, and the one or more PLL signals are used to generate particulate matter concentration data that is provided to a monitoring system.

In some embodiments, the DFCS-enabling hardware is communicatively coupled to the mobile device via a data cable or a wireless connection. In some embodiments, the mobile device is configured to measure a concentration of one or more substances in the sample by analyzing, using a machine learning algorithm, the signal output data. In some embodiments, the machine learning algorithm comprises at least one of: a linear regression algorithm, a logistic regression algorithm, a decision tree algorithm, a support vector machine (SVM) algorithm, a naive Bayes algorithm, a k-nearest neighbors (KNN) algorithm, a k-means algorithm, a random forest algorithm, a recurrent neural network (RNN), a convolutional neural network (CNN), a transformer, a generative adversarial network (GAN), or an artificial neural network. In some embodiments, the one or more substances comprise a chemical compound or gas. In some embodiments, the attachment comprises a wand-shaped form factor. In some embodiments, the attachment comprises an inline attachment form factor that is configured to mate with a data port of the mobile device. In some embodiments, the attachment comprises a sled-style form factor with a mounting device that is configured to receive and attach to at least a portion of the mobile device. In some embodiments, the sample comprises a gas, liquid, or solid.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 depicts an example gas detection system in accordance with some embodiments of the present disclosure in accordance with some embodiments of the present disclosure;

FIG. 2A and 2B depict example configurations for passive/short range detection in accordance with some embodiments of the present disclosure;

FIG. 3A and 3B depict example configurations for environmental detection in accordance with some embodiments of the present disclosure;

FIG. 4 depicts an example wand-shaped form factor in accordance with some embodiments of the present disclosure;

FIG. 5 depicts an example inline attachment form factor in accordance with some embodiments of the present disclosure;

FIG. 6 depicts an example sled-style attachment form factor in accordance with some embodiments of the present disclosure; and

FIG. 7 depicts a flow diagram illustrating an example process for performing substance detection in accordance with some example embodiments of the present disclosure.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc., are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As described above, there are many disadvantages associated with conventional spectroscopy devices. Various example embodiments of the present disclosure overcome such challenges and provide various technical advancements and improvements. In particular, various embodiments of the present disclosure address a demand for portable and accurate real-time molecular analysis. In some embodiments, DFCS-enabling hardware is disclosed for providing a mobile device with real-time molecular analysis capabilities.

In accordance with various embodiments of the present disclosure, a spectroscopic subsystem comprising an attachment for coupling with a mobile device is provided. In some embodiments, the spectroscopic subsystem comprises DFCS-enabling hardware that provides DFCS capabilities to a mobile device. In some embodiments, the DFCS-enabling hardware allows end-users to perform DFCS-based molecular analysis directly from a mobile device coupled with the attachment. In some embodiments, the DFCS capabilities comprise real-time detection and identification of various substances associated with healthcare diagnostics, food safety, or environmental monitoring. In some embodiments, the mobile device is configured to analyze or detect, using the spectroscopic subsystem, chemical compounds, gases, or other substances in real-time.

In some embodiments, the DFCS-enabling hardware comprises a DFCS-enabling chip and/or circuit that provides improved resolution and sensitivity spectroscopy in a compact, portable format via a mobile device without the size constraints of conventional spectrometers. Accordingly, the DFCS-enabling hardware may be configured with a mobile device to perform on-the-go analysis without expensive, specialized equipment, and/or training. When used in tandem with other software solutions, a DFCS-integrated mobile device may provide comprehensive data analysis, predictive maintenance, and enhanced safety measures for industrial and commercial applications. Various embodiments of the present disclosure leverage the precision and broad bandwidth of DFCS to provide precise detection and identification of various substances. In some embodiments, DFCS functionality that is integrated into a mobile device is applicable across various industries, including healthcare, environmental monitoring, and industrial safety.

In general, the term mobile device may refer to, for example, one or more mobile phones, tablets, phablets, notebooks, laptops, the like, and/or any combination of devices or entities adapted to perform the functions, operations, and/or processes described herein.

A mobile device may include an antenna, a transmitter (e.g., radio), a receiver (e.g., radio), and a processing element (e.g., complex programmable logic devices (CPLDs), microprocessors, multi-core processors, coprocessing entities, application-specific instruction-set processors (ASIPs), microcontrollers, and/or controllers) that provides signals to and receives signals from the transmitter and receiver, correspondingly. The signals provided to and received from the transmitter and the receiver, correspondingly, may include signaling information/data in accordance with air interface standards of applicable wireless systems. In this regard, the mobile device may be capable of operating with one or more air interface standards, communication protocols, modulation types, and access types. More particularly, the mobile device may operate in accordance with any of a number of wireless communication standards and protocols. In a particular embodiment, the mobile device may operate in accordance with multiple wireless communication standards and protocols, such as new radio (NR), general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or the like.

Via these communication standards and protocols, a mobile device may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile device may also download changes, add-ons, and updates, for instance, to its firmware, software (e.g., including executable instructions, applications, program modules), and operating system.

According to one embodiment, a mobile device may include location determining aspects, devices, modules, functionalities, and/or similar words used herein interchangeably. For example, the mobile device may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the mobile device’s position in connection with a variety of other systems, including cellular towers, Wi-Fi access points, and/or the like. Similarly, the mobile device may include indoor positioning aspects, such as a location module adapted to acquire, for example, latitude, longitude, altitude, geocode, course, direction, heading, speed, time, date, and/or various other information/data. Some of the indoor systems may use various position or location technologies including radio-frequency identification (RFID) tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

A mobile device may also comprise a user interface (that may include an output device (e.g., display, speaker, tactile instrument, etc.) coupled to a processing element) and/or a user input interface (coupled to a processing element). For example, the user interface may be a user application, browser, user interface, and/or similar words used herein interchangeably executing on and/or accessible via the mobile device to interact with and/or cause display of information/data, as described herein. The user input interface may comprise any of a plurality of input devices (or interfaces) allowing the mobile device to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the mobile device and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The mobile device may also include volatile storage or memory and/or non-volatile storage or memory, which may be embedded and/or may be removable. For example, the non-volatile memory may be read-only memory (ROM); programmable read-only memory (PROM); erasable programmable read-only memory (EPROM); electrically erasable programmable read-only memory (EEPROM), such as flash memory; and/or the like. The volatile memory may be random access memory (RAM), dynamic random access memory (DRAM), static random access memory (SRAM), synchronous dynamic random access memory (SDRAM), cache memory (including various levels), register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the mobile device. As indicated, this may include a user application that is resident on the mobile device or accessible through a browser or other user interface.

In various embodiments, the mobile device may be embodied as an artificial intelligence (AI) computing entity. Accordingly, the mobile device may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

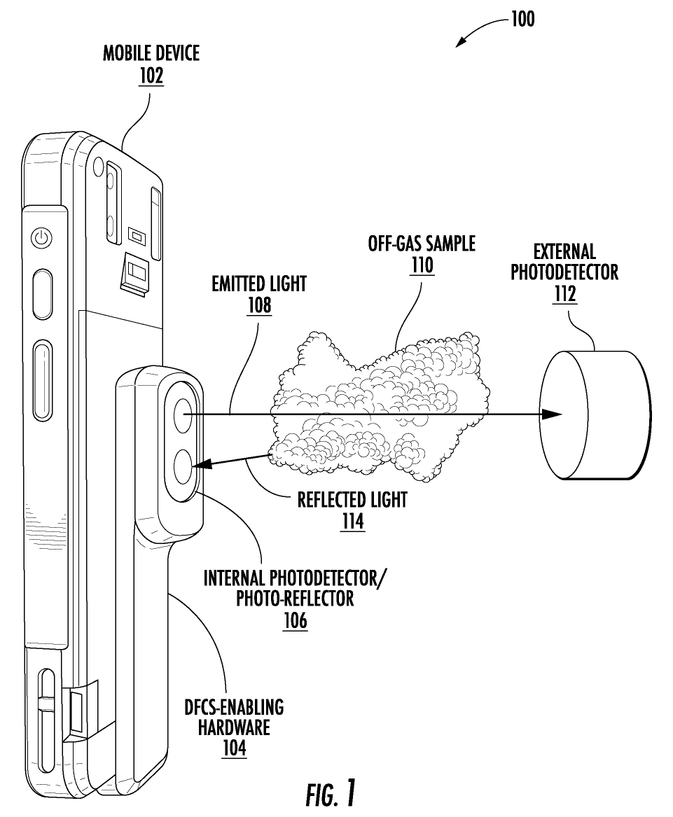

FIG. 1 depicts an example gas detection system 100 in accordance with some embodiments of the present disclosure. The gas detection system 100 comprises a mobile device 102 that is coupled with DFCS-enabling hardware 104 that allows the mobile device 102 to perform DFCS-based molecular analysis of a sample area comprising an off-gas sample 110. In some embodiments, the DFCS-enabling hardware 104 comprises a spectroscopic subsystem comprising various components, such as a laser emitter/light source, and/or an optical coupling system, that are coupled to the mobile device 102 via an attachment and/or mounting device. The DFCS-enabling hardware 104 may be communicatively coupled to the mobile device 102 via data cables (e.g., universal serial bus (USB) C) and/or wireless connections (e.g., near-field communication, Bluetooth, etc.).

The DFCS-enabling hardware 104 may comprise a laser emitter that utilizes two optical frequency combs that emit laser light (e.g.., emitted light 108) at precise, evenly spaced intervals across a broad spectrum of optical frequencies. For example, the two optical frequency combs may be generated using mode-locked lasers or optical parametric oscillators. In some embodiments, the optical frequency combs comprise a pump comb and a probe comb that are combined to focus light onto a sample area. For example, emitted light 108 from the optical frequency combs may interact with an off-gas sample 110, leading to various types of nonlinear interactions such as four-wave mixing. The off-gas sample 110 may comprise a gas, liquid, and/or solid. After interacting with the off-gas sample 110, transmitted and/or reflected light (e.g., comprising at least a portion of the emitted light 108 transmitted through and/or reflected from the off-gas sample 110) may be collected by an external photodetector 112 and analyzed, for example, using heterodyne detection to measure phase and amplitude information of the transmitted light, which may be used to characterize the off-gas sample 110.

The external photodetector 112 may be configured to receive, detect, and/or interact with the laser emitter at a distant range covering a sample area. For example, the external photodetector 112 may detect at least a portion of the emitted light 108 after passing through (e.g., transmitted light) and/or reflecting off (e.g., reflected light 114) the off-gas sample 110. The DFCS-enabling hardware 104 may further comprise an optical coupling system. The optical coupling system may comprise components, such as lenses and optical fibers, that direct and/or couple the emitted light 108 from the laser emitter of the DFCS-enabling hardware 104 into an environment (e.g., comprising the off-gas sample 110) for a desired analysis to take place, thereby ensuring efficient interaction between the emitted light 108 and the off-gas sample 110. The DFCS-enabling hardware 104 further comprises an internal photodetector/photo-reflector 106 that are configured to receive, detect, and/or interact with the laser emitter at a proximate range, which may allow for tracking movements and monitoring the off-gas sample 110 more accurately.

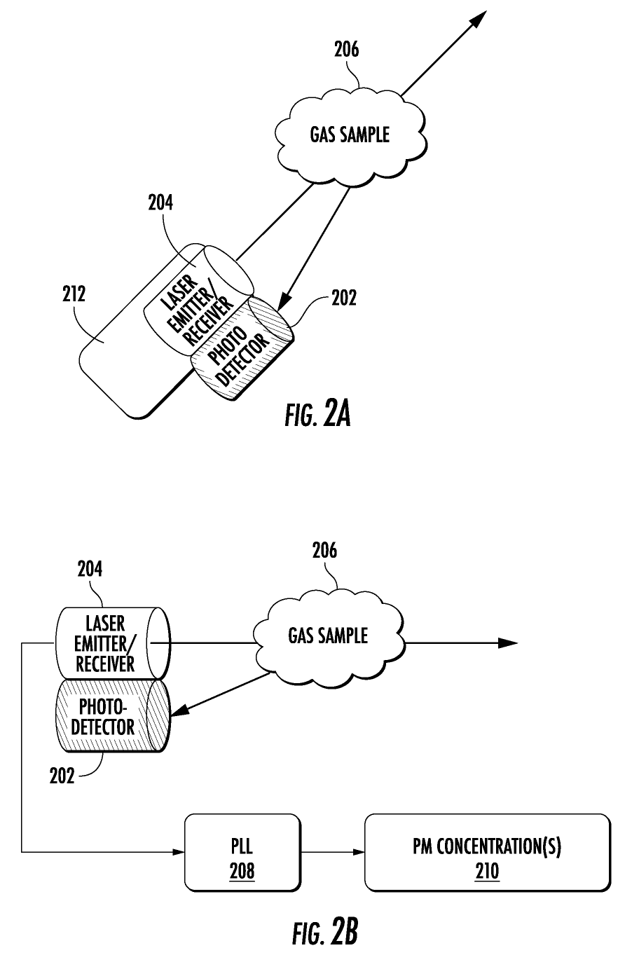

FIG. 2A and 2B depict example configurations for passive/short range detection in accordance with some embodiments of the present disclosure. A mobile device 212 (e.g., mobile device 102) is configured (e.g., via a DFCS-enabling hardware 104) with an internal photodetector 202 (e.g., internal photodetector/photo-reflector 106) and a laser emitter/receiver 204 that is adjacent to the internal photodetector 202. By doing so, short range detection of an off-gas sample 206 may be provided by the internal photodetector 202 and/or laser emitter/receiver 204 detecting and/or captured emitted light from the laser emitter/receiver 204 that is reflected from the off-gas sample 206 to a location that is adjacent to the laser emitter/receiver 204.

In some embodiments, a camera and/or photodetector of the laser emitter/receiver 204 is additionally, and/or alternatively (e.g., separate from the internal photodetector 202) configured to measure scattering/turbidity of the off-gas sample 206. In some embodiments, the camera and/or photodetector of the laser emitter/receiver 204 may directly measure at least a portion of emitted light from a laser emitter of the laser emitter/receiver 204 that does not pass through the off-gas sample 206 to assist with signal processing (e.g., for signal normalization).

The internal photodetector 202 and/or laser emitter/receiver 204 may generate and/or provide a signal output representative of one or more wavelength and/or absorption properties that are measured from detected and/or captured emitted light. The signal output may be used by a phase-locked loop (PLL) control system to generate and/or provide PLL signals 208, which in turn, may be used to generate and/or provide particulate matter concentration data 210 to a monitoring system. In some embodiments, signal output generated and/or provided by the internal photodetector 202 and/or laser emitter/receiver 204 may be provided to and processed by a machine learning algorithm to measure the concentration of multiple substances in the off-gas sample 206. Various embodiments of the present disclosures may implement artificial intelligence and/or machine learning algorithms for analysis (e.g., of the off-gas sample 206 via the signal output generated and/or provided by the internal photodetector 202 and/or laser emitter/receiver 204) that include, but are not limited to, linear regression algorithm, logistic regression algorithm, decision tree algorithm, support vector machine (SVM) algorithm, naive Bayes algorithm, k-nearest neighbors (KNN) algorithm, k-means algorithm, random forest algorithm, recurrent neural network (RNN), convolutional neural network (CNN), a transformer, generative adversarial network (GAN), artificial neural network, and/or the like, to generate the predictive model.

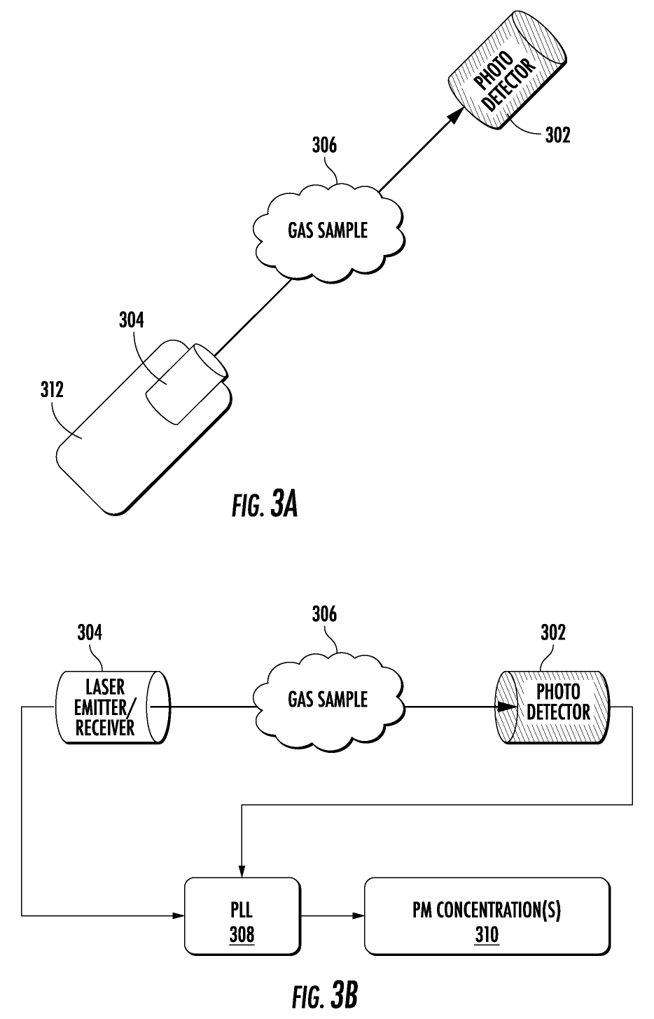

FIG. 3A and 3B depict example configurations for environmental detection in accordance with some embodiments of the present disclosure. A mobile device 312 (e.g., mobile device 102) is configured (e.g., via a DFCS-enabling hardware 104) with a laser emitter/receiver 304 that is at a distance from an external photodetector 302 (e.g., external photodetector 112). By doing so, environmental detection of an off-gas sample 306 may be provided by the external photodetector 302 and/or laser emitter/receiver 304 detecting and/or captured emitted light from the laser emitter/receiver 304 that passes through the off-gas sample 306 towards the external photodetector 302. Similar to laser emitter/receiver 204, a camera and/or photodetector of the laser emitter/receiver 304 is additionally, and/or alternatively (e.g., separate from the external photodetector 302) configured to measure scattering/turbidity of the off-gas sample 206 and/or at least a portion of emitted light from a laser emitter of the laser emitter/receiver 304 that does not pass through the off-gas sample 306.

The external photodetector 302 may generate signal output representative of wavelength and absorption properties that are measured from detected and/or captured emitted light. Signal output generated by the external photodetector 302 may be combined with signal output generated by the laser emitter/receiver 304 and/or an internal photodetector (e.g., internal photodetector 202), wherein the signal output generated by the internal photodetector is representative of one or more wavelength and/or absorption properties of light detected by the internal photodetector (e.g., adjacent to the laser emitter/receiver). A combination of the signal outputs generated by the external photodetector 302, the laser emitter/receiver 304, and/or the internal photodetector may be provided to and used by a PLL control system to generate and/or provide PLL signals 308, which in turn, may be used to generate and/or provide particulate matter concentration data 310 to a monitoring system.

In some embodiments, signal output generated and/or provided by the external photodetector 302, the laser emitter/receiver 304, and/or the internal photodetector may be provided to and processed by a machine learning algorithm to measure the concentration of multiple substances in the off-gas sample 306. Various embodiments of the present disclosures may implement artificial intelligence and/or machine learning algorithms for analysis (e.g., of the off-gas sample 306 via the signal output generated and/or provided by the external photodetector 302, the laser emitter/receiver 304, and/or the internal photodetector) that include, but are not limited to, linear regression algorithm, logistic regression algorithm, decision tree algorithm, SVM algorithm, naive Bayes algorithm, KNN algorithm, k-means algorithm, random forest algorithm, RNN, CNN, a transformer, GAN, artificial neural network, and/or the like, to generate the predictive model.

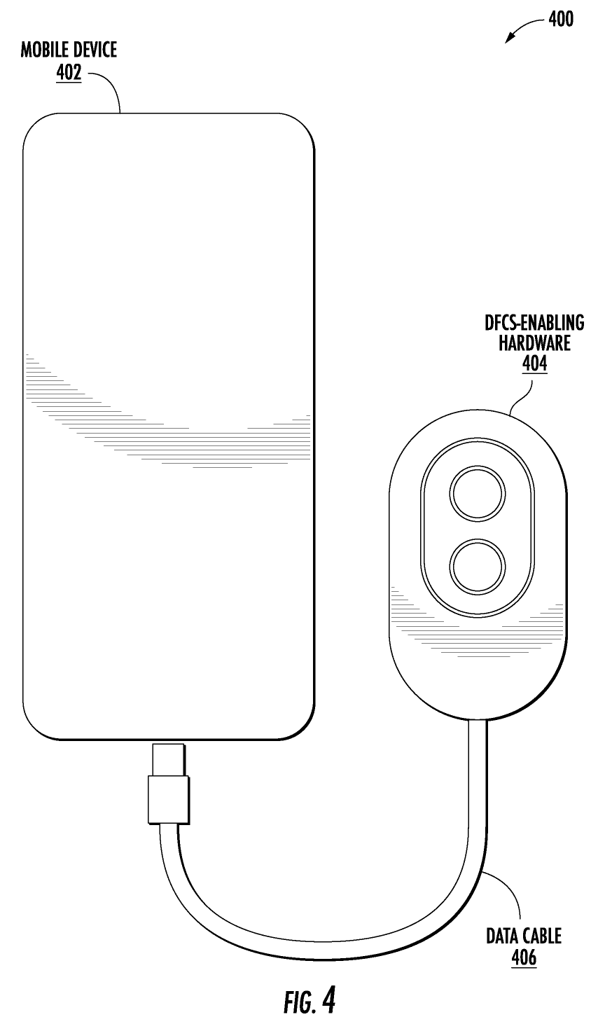

According to various embodiments of the present disclosure, a DFCS-enabling hardware (e.g., DFCS-enabling hardware 104) comprises any one of the form factors depicted in FIG. 4, 5, or 6.

FIG. 4 depicts an example wand-shaped form factor 400 in accordance with some embodiments of the present disclosure. The wand-shaped form factor 400 comprises a DFCS-enabling hardware 404 that is communicatively coupled to a mobile device 402 via a data cable 406.

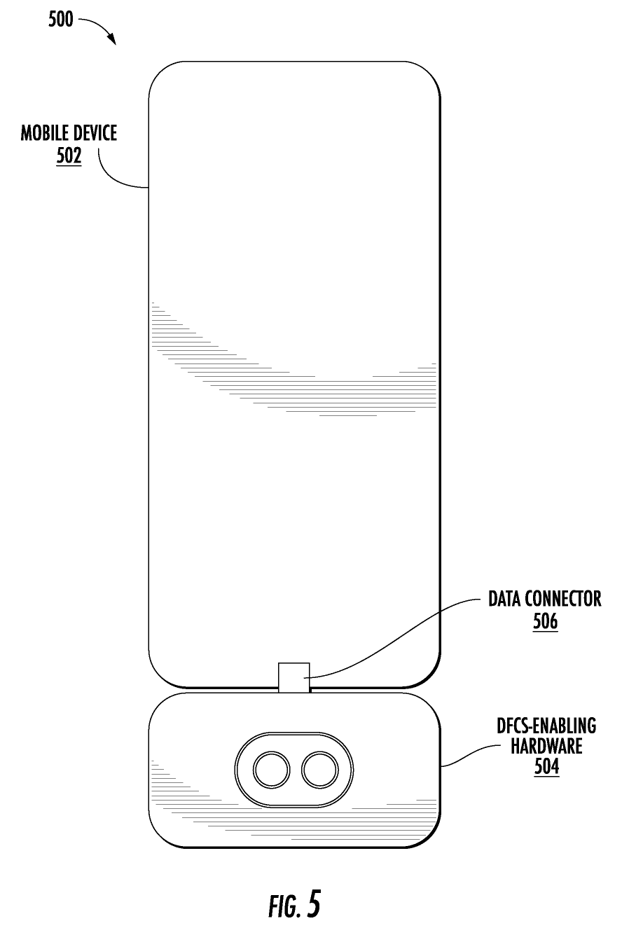

FIG. 5 depicts an example inline attachment form factor 500 in accordance with some embodiments of the present disclosure. The inline attachment form factor 500 comprises a DFCS-enabling hardware 504 that is attached inline and/or mated to a data port of a mobile device 502 via a data connector 506 for establishing a wired connection.

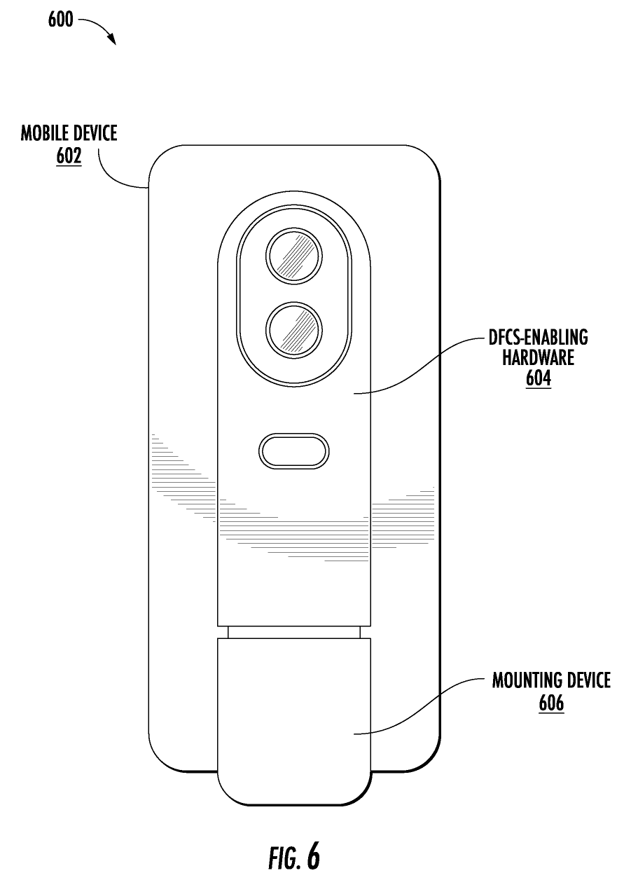

FIG. 6 depicts an example sled-style attachment form factor 600 in accordance with some embodiments of the present disclosure. The sled-style attachment form factor 600 comprises a DFCS-enabling hardware 604 that is attached to a mounting device 606. The mounting device 606 is configured to receive and attach to at least a portion of a mobile device 602 such that the DFCS-enabling hardware 604 is securely attached to a surface (e.g., rear) of the mobile device 602. The DFCS-enabling hardware 604 may be communicatively coupled to a data port of the mobile device 602 to establish a wired connection or communicatively coupled to the mobile device 602 via a wireless connection.

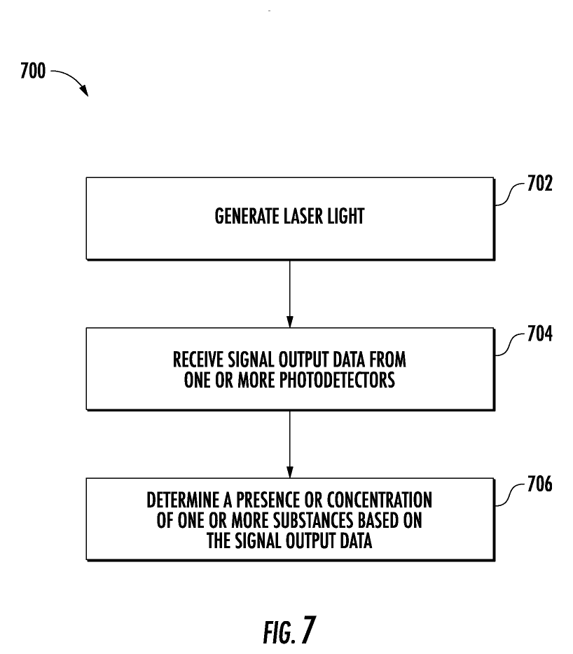

FIG. 7 depicts a flow diagram illustrating an example process 700 for performing substance detection in accordance with some example embodiments of the present disclosure. It is noted that each block of a flowchart, and combinations of blocks in the flowchart, may be implemented by various means such as hardware, firmware, circuitry, and/or other devices associated with execution of software including one or more computer program instructions. For example, one or more of the steps/operations described in FIG. 7 may be embodied by computer program instructions, which may be stored by a non-transitory memory of an apparatus employing an embodiment of the present disclosure and executed by a processor component in an apparatus. For example, these computer program instructions may direct the processor component to function in a particular manner, such that the instructions stored in the computer-readable storage memory produce an article of manufacture, the execution of which implements the function specified in the flowchart block(s).

In some embodiments, the process 700 begins at step/operation 702 when a laser light is generated. In some embodiments, the laser light comprises a spectrum of optical frequencies. For example, the spectrum of optical frequencies may comprise a pattern of evenly spaced spectral lines. The laser light may be emitted at a direction towards an off-gas sample and may interact with an off-gas sample and/or reflect off one or more photo-reflectors.

In some embodiments, subsequent to step/operation 702, the example process proceeds to step/operation 704, where signal output data is received from one or more photodetectors. The one or more photodetectors (e.g., an internal photodetector and/or an external photodetector) may detect light from the laser light and generate the signal output data based on one or more wavelength and/or absorption properties measured from at least a portion of the laser light (e.g., transmitted through an off-gas sample and/or reflected light from the off-gas sample) detected by the one or more photodetectors.

In some embodiments, subsequent to step/operation 704, the example process proceeds to step/operation 706, where a presence or concentration of one or more substances are determined based on the signal output data. The signal output data may be continuously monitored and collected to provide real-time information on the presence or concentration of various substances in the off-gas sample. The collected data may be analyzed (e.g., via machine learning algorithms) to identify any hazardous substances and determine appropriate actions (e.g., alerts, messages, system control actions) based on the analysis. For example, a measured wavelength and/or absorption property corresponding to the output signal may be compared to reference spectra, and based on the comparison, one or more substance concentrations in an off-gas sample may be accurately determined in real time.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A system comprising:
an attachment configured to couple with a mobile device; and
dual frequency comb spectroscopy (DFCS)-enabling hardware that is configured to enable the mobile device to perform DFCS-based molecular analysis of a sample area comprising a sample, wherein the DFCS-enabling hardware comprises:
a laser emitter configured to generate two optical frequency combs that emit laser light at evenly spaced intervals across a broad spectrum of optical frequencies, wherein:
(i) the laser light is directed towards the sample area, and
(ii) at least a portion of the laser light is received by at least one photodetector configured to:
(a) receive at least a portion of the laser light after interacting with the sample, and
(b) generate signal output data based on one or more wavelength or absorption properties corresponding to the portion of the laser light; and
an optical coupling system configured to direct the laser light from the laser emitter into the sample area.

2. The system of claim 1, wherein the two optical frequency combs comprise a pump comb and a probe comb that are combined to focus light onto the sample area.

3. The system of claim 1, wherein:
(i) the portion of the laser light is reflected from the sample, and
(ii) the at least one photodetector comprises an internal photodetector that is positioned adjacent to the laser emitter and is configured to receive the portion of the laser light at a proximate range.

4. The system of claim 1, wherein:
(i) the portion of the laser light is transmitted through the sample, and
(ii) the at least one photodetector comprises an external photodetector positioned at a distance from the laser emitter and is configured to receive the portion of the laser light at a distant range that covers the sample area.

5. The system of claim 1, wherein the at least one photodetector comprises:
an internal photodetector positioned adjacent to the laser emitter and configured to detect reflected light from the sample; and
an external photodetector positioned at a distance from the laser emitter and configured to detect transmitted light that passes through the sample.

6. The system of claim 5, wherein a first signal output generated by the external photodetector is combined with a second signal output generated by the internal photodetector.

7. The system of claim 6, wherein:
(i) a combination of the first signal output and the second signal output is provided to a phase-locked loop (PLL) control system to generate one or more PLL signals, and
(ii) the one or more PLL signals are used to generate particulate matter concentration data that is provided to a monitoring system.

8. The system of claim 1, wherein the DFCS-enabling hardware is communicatively coupled to the mobile device via a data cable or a wireless connection.

9. The system of claim 1, wherein the mobile device is configured to measure a concentration of one or more substances in the sample by analyzing, using a machine learning algorithm, the signal output data.

10. The system of claim 9, wherein the machine learning algorithm comprises at least one of: a linear regression algorithm, a logistic regression algorithm, a decision tree algorithm, a support vector machine (SVM) algorithm, a naive Bayes algorithm, a k-nearest neighbors (KNN) algorithm, a k-means algorithm, a random forest algorithm, a recurrent neural network (RNN), a convolutional neural network (CNN), a transformer, a generative adversarial network (GAN), or an artificial neural network.

11. The system of claim 9, wherein the one or more substances comprise a chemical compound or gas.

12. The system of claim 1, wherein the attachment comprises a wand-shaped form factor.

13. The system of claim 1, wherein the attachment comprises an inline attachment form factor that is configured to mate with a data port of the mobile device.

14. The system of claim 1, wherein the attachment comprises a sled-style form factor with a mounting device that is configured to receive and attach to at least a portion of the mobile device.

15. The system of claim 1, wherein the sample comprises a gas, liquid, or solid.
